(19) United States
(12) Patent Application Publication
(10) Pub. No.: US 2015/0109792 A1
(43) Pub. Date: Apr. 23, 2015

(54) Lighting Apparatus

(71) Applicant: Toshiba Lighting & Technology Corporation, Yokosuka-shi (JP)

(72) Inventors: Masazumi Ishida, Yokosuka-shi (JP); Junichi Kimiya, Yokosuka-shi (JP)

(73) Assignee: Toshiba Lighting & Technology Corporation, Yokosuka-shi (JP)

(21) Appl. No.: 14/340,598

(22) Filed: Jul. 25, 2014

(30) Foreign Application Priority Data
Oct. 17, 2013 (JP) 2013-215999

(51) Int. Cl. F21V 29/00; F21V 7/22; F21K 99/00

(52) U.S. Cl. CPC F21V 29/004; F21K 9/50; F21V 7/22
USPC 362/294

(57) ABSTRACT

According to one embodiment, a lighting apparatus is provided in which positioning of a light-emitting module including a ceramic board is easy and light extraction efficiency is improved. The lighting apparatus includes an apparatus body; a light-emitting module which includes a light transmissive ceramic board and a light-emitting element provided on one surface side of the ceramic board and is disposed in the apparatus body; a thermal radiator including a light-emitting module connection part to which the light-emitting module is heat-conductively connected; a heat conductive sheet intervening between the light-emitting module connection part and the light-emitting module and having insulation properties; and a reflection member intervening between the heat conductive sheet and other surface side of the ceramic board and having light reflective properties and sliding properties.

### CROSS-REFERENCE TO RELATED APPLICATIONS

This application is based upon and claims the benefit of priority from the prior Japanese Patent Application No. 2013-215999, filed on Oct. 17, 2013, the entire contents of which are incorporated herein by reference.

### FIELD

Embodiments described herein relate generally to a lighting apparatus in which heat generated in a light-emitting module is radiated through a thermal radiator.

### BACKGROUND

Hitherto, a flat lamp apparatus, such as a lamp apparatus using, for example, a GH76p cap, is proposed. In this lamp apparatus, a light-emitting module and a lighting circuit are disposed in a housing (apparatus body) provided with an opening at one end side, and a thermal radiation member (thermal radiator) is attached to the other end side of the housing. The light-emitting module is thermally connected to the thermal radiation member, and heat generated in the light-emitting module is conducted to the thermal radiation member. Further, the heat is conducted from the thermal radiation member to a luminaire side and is radiated.

The light-emitting module includes a module board and a light-emitting element, for example, an LED element mounted on the module board. The module board is formed of a metal plate having high heat conductivity, for example, an aluminum plate or a ceramic plate. Since the ceramic plate can be directly mounted with the LED element because of the insulation properties thereof, the convenience as the module board is high.

In order to efficiently conduct the heat generated in the light-emitting module from the module board to the thermal radiation member, a heat conductive sheet may intervene between the module board and the thermal radiation member. The heat conductive sheet has cushion properties (elasticity), and is in close contact with the module board and the thermal radiation member so that the contact area becomes large. The heat conductive sheet and the module board are provided to be sandwiched between a holder (attachment base) and the thermal radiation member.

The light-emitting module is provided to be positioned on the center line of the opening of the housing. Since the heat conductive sheet has elasticity so as to be in close contact with both the module board and the thermal radiation member, there is a defect that the positioning of the light-emitting module to the center line of the opening of the housing by moving the module board on the heat conductive sheet or by moving the module board and the heat conductive sheet on the surface of the thermal radiation member is not easy.

Besides, if a translucent, namely, light transmissive ceramic plate is used as the module board, in the emission light of the LED element passing through the ceramic board and incident on the heat conductive sheet, reflected light toward the opening side of the housing is reduced because of low reflectivity of the heat conductive sheet. Thus, there is a defect that the light extraction efficiency of the lamp apparatus is reduced by this.

### BRIEF DESCRIPTION OF THE DRAWINGS

FIG. 1 is a schematic sectional view of a lighting apparatus of an embodiment.

FIG. 2 is a schematic sectional view of a part of the lighting apparatus.

FIG. 3 is a schematic decomposed perspective view of the lighting apparatus.

FIG. 4 is a schematic perspective view when viewed from the lower side of the lighting apparatus.

FIG. 5 is a schematic perspective view when viewed from the upper side of the lighting apparatus.

FIG. 6 is a schematic sectional view of a luminaire using the lighting apparatus.

### DETAILED DESCRIPTION

In view of the above circumstances, exemplary embodiments described herein provide a lighting apparatus in which positioning of a light-emitting module including a ceramic board is easy and light extraction efficiency is improved.

According to one embodiment, a lighting apparatus includes an apparatus body, a light-emitting module, a thermal radiator, a heat conductive sheet and a reflection member.

The light-emitting module is disposed in the apparatus body and includes a light transmissive ceramic board and a light-emitting element provided on one surface side of the ceramic board. The thermal radiator includes a light-emitting module connection part, and the light-emitting module is heat-conductively connected to the light-emitting module connection part.

The heat conductive sheet has insulation properties, and intervenes between the light-emitting module connection part of the thermal radiator and the light-emitting module. The reflection member has light reflective properties and sliding properties, and intervenes between the heat conductive sheet and the other surface side of the ceramic board of the light-emitting module.

According to one embodiment, a lighting apparatus includes an apparatus body; a light-emitting module which includes a light transmissive ceramic board and a light-emitting element provided on one surface side of the ceramic board and is disposed in the apparatus body; a thermal radiator including a light-emitting module connection part to which the light-emitting module is heat-conductively connected; a heat conductive sheet intervening between the light-emitting module connection part and the light-emitting module and having insulation properties; and a reflection member intervening between the heat conductive sheet and other surface side of the ceramic board and having light reflective properties and sliding properties.

For example, according to one embodiment, a lighting apparatus includes an apparatus body; a light-emitting module which includes a light transmissive ceramic board and a light-emitting element provided on one surface side of the ceramic board and is disposed in the apparatus body; a thermal radiator including a light-emitting module connection part to which the light-emitting module is heat-conductively connected; a heat conductive sheet intervening between the light-emitting module connection part and the light-emitting module and having insulation properties; and a reflection member intervening between the heat conductive sheet and other surface side of the ceramic board and made of a metal thin layer. The heat conductive sheet is made of, for example, an insulating resin.

According to the lighting apparatus of the embodiment, the reflection member conducts heat generated in the light-emitting module from the ceramic board to the thermal radiator through the heat conductive sheet. Light emitted from the light-emitting element and passing through the ceramic board is efficiently reflected to the light-emitting module side by the light reflective properties of the reflection member. Besides, the light-emitting module can be easily moved on a surface of the reflection member due to the sliding properties thereof, and positioning of the light-emitting module relative to a specified irradiation direction is expected to be facilitated.

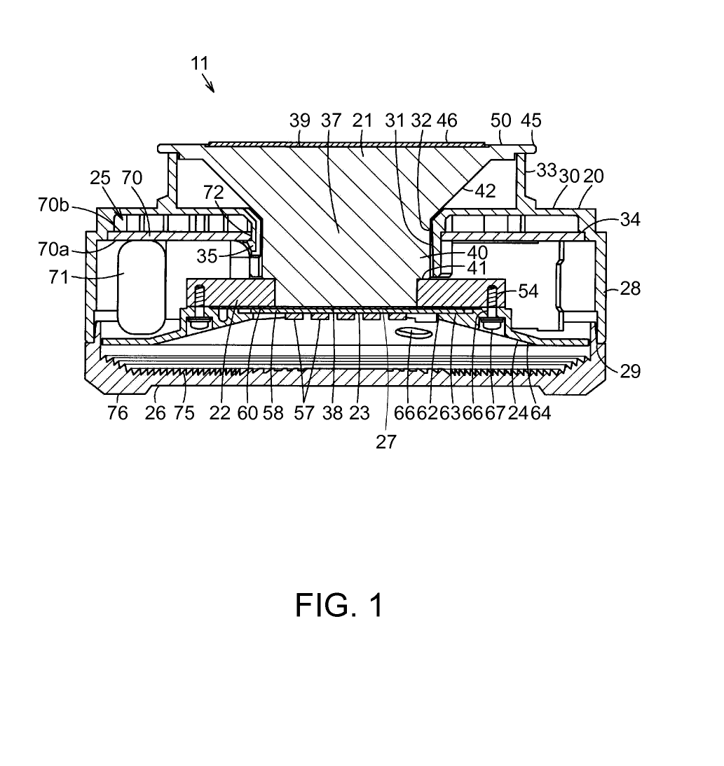

Hereinafter, an embodiment will be described with reference to FIG. 1 to FIG. 6.

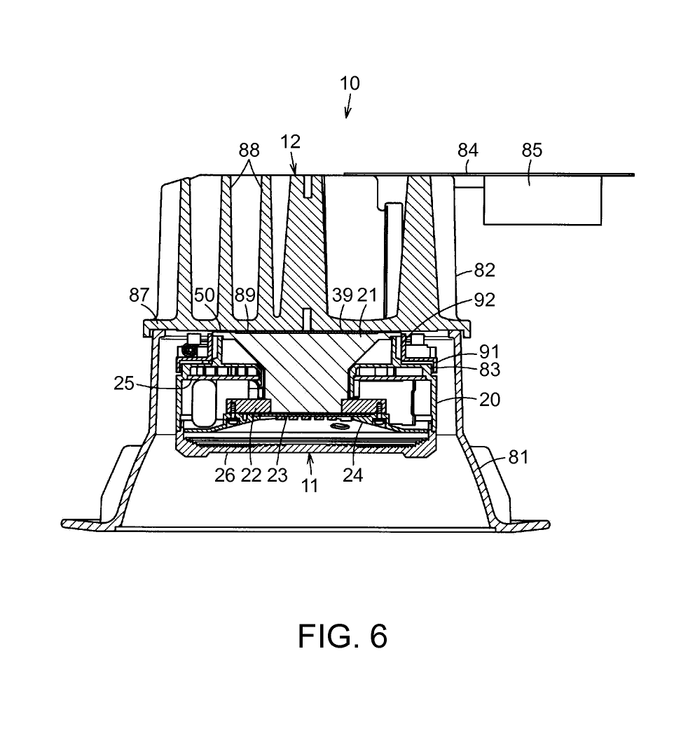

In FIG. 6, a luminaire 10 is an embedded-type luminaire such as a downlight. The luminaire 10 includes a lighting apparatus 11 and a luminaire apparatus 12 to which the lighting apparatus 11 is detachably attached. In this embodiment, the lighting apparatus 11 is a flat-type lamp apparatus and will be referred to as a lamp apparatus 11 in the following description.

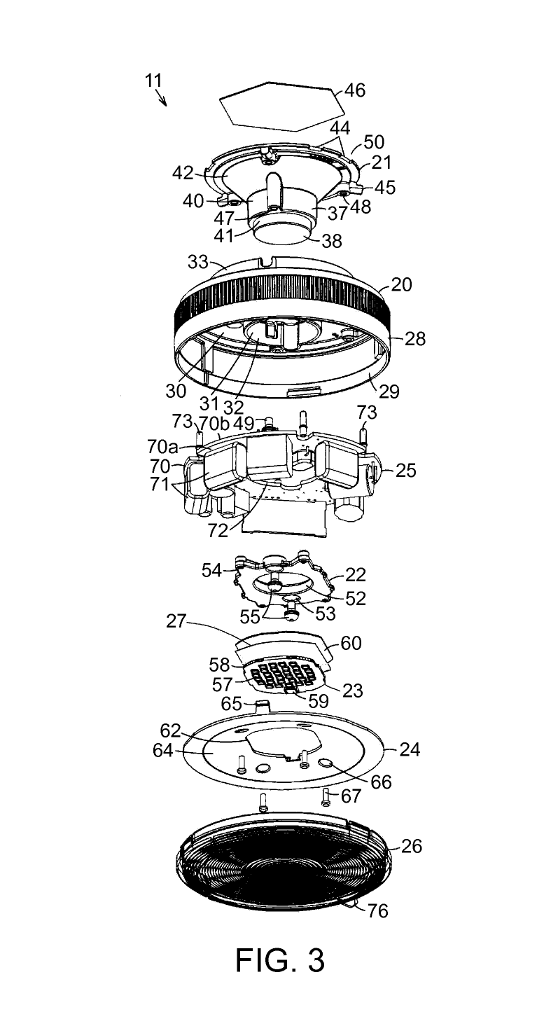

The lamp apparatus 11 is constructed as shown in FIG. 1 to FIG. 5. In FIG. 3, the lamp apparatus 11 includes a housing 20 as an apparatus body, a thermal radiator 21 (heat sink), a attachment base 22, a light-emitting module 23, a reflector 24, a lighting circuit 25, a translucent cover 26 (light transmissive cover) and a reflection member 27. Incidentally, in the following description, one end side of the lamp apparatus 11 and a light irradiation side is made a lower side, and the other end side and the opposite side to the light irradiation direction is made an upper side.

The housing 20 is formed of a material having insulation properties, such as synthetic resin, into a cylindrical shape, and includes a peripheral surface part 28, an opening part 29 at the lower side of the peripheral surface part 28 and a closing part 30 at the upper side of the peripheral surface part 28. A cylindrical insertion part 32 forming an insertion port 31 opening in an up-and-down direction is protrudingly provided in the housing 20 at the center of the closing part 30. An annular projection 33 to which the thermal radiator 21 is attached is provided protrudingly upward between the peripheral part of the closing part 30 and the insertion part 32. As shown in FIG. 1, a circuit board installation part 34 in which the lighting circuit 25 (circuit board 70) is positioned and disposed is formed inside the housing 20 and at the peripheral part of the closing part 30 and the outer peripheral part of the insertion part 32. Further, a locking part 35 for locking the lighting circuit 25 (circuit board 70) between itself and the circuit board installation part 34 is provided at the outer peripheral part of the insertion part 32.

The thermal radiator 21 is integrally formed of a metal material such as aluminum die cast. The thermal radiator 21 includes a columnar support part 37, a light-emitting module connection part 38 formed at the lower side of the support part 37, and an external thermal radiation part 39 formed at the upper side of the support part 37.

A columnar part 40 insertable in the insertion part 32 is formed at the lower side of the support part 37, and a step part 41 is formed at the lower periphery of the columnar part 40. A taper part 42 whose cross-sectional area becomes large toward the upper external thermal radiation part 39 is formed at the upper side of the support part 37. The inclination angle of the taper part 42 is set to, for example, 45°.

The light-emitting module connection part 38 is a circular contact surface formed into a plane shape on the tip surface of the support part 37, and its area is smaller than the cross-sectional area of the support part 37 and is smaller than the area of the external thermal radiation part 39.

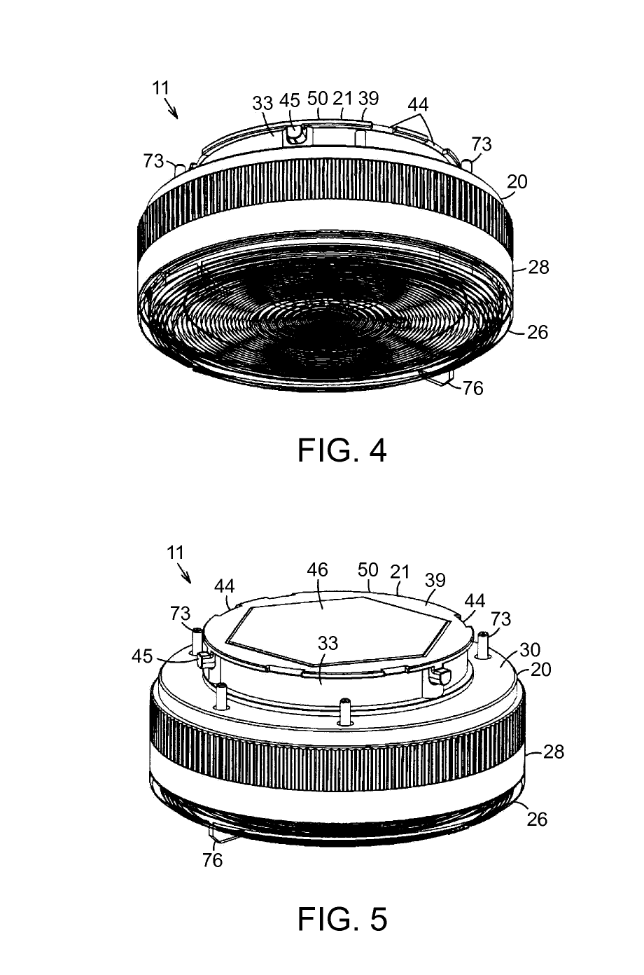

The external thermal radiation part 39 is formed into a disk shape larger than the support part 37 and the light-emitting module connection part 38, and is disposed on the projection 33 in a state where the peripheral part projects in an outer diameter direction more than the projection 33. As shown in FIG. 4, plural key grooves 44 and plural keys 45 are provided at specified positions on the peripheral part of the external thermal radiation part 39. As shown in FIG. 5, a heat conductive sheet 46 is attached to the upper surface of the external thermal radiation part 39.

In FIG. 3, plural bosses 47 for screwing the attachment base 22 are provided on the periphery of the support part 37, and plural bosses 48 for screwing to the housing 20 are provided on the peripheral part of the external thermal radiation part 39. The housing 20 and the thermal radiator 21 are fixed to each other by screwing the plural screws 49 to the plural bosses 48 of the thermal radiator 21 from the inside of the housing 20.

A cap part 50 having a specified standard size is constructed of the upper side including the projection 33 of the housing 20 and the external thermal radiation part 39 of the thermal radiator 21.

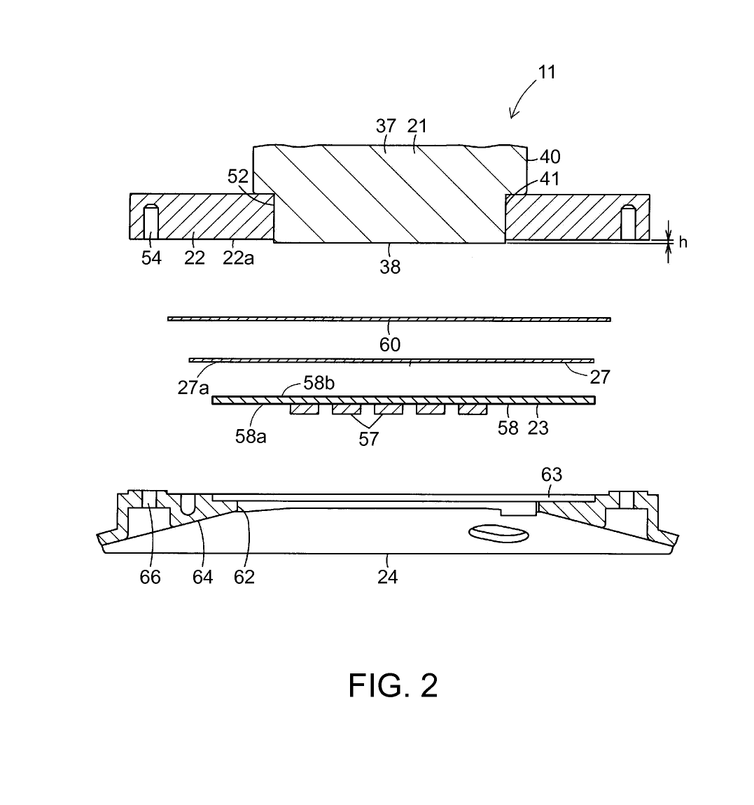

The attachment base 22 is formed of a material having insulation properties such as synthetic resin. A hole part 52 through which the light-emitting module connection part 38 is inserted is formed at the center of the attachment base 22. Plural attachment holes 53 for screwing to the thermal radiator 21 are formed on the peripheral part of the attachment base 22, and plural attachment holes 54 for screwing the periphery of the reflector 24 are formed. In a state where the light-emitting module connection part 38 is inserted through the hole part 52 and the attachment base 22 is disposed around the light-emitting module connection part 38, the plural screws 55 are screwed from the attachment holes 53 to the plural bosses 47 of the thermal radiator 21, so that the attachment base 22 is fixed to the thermal radiator 21. In the state where the attachment base 22 is fixed to the thermal radiator 21, as shown in FIG. 2, the light-emitting module connection part 38 protrudes from the mounting surface 22a of the attachment base 22. A projection amount h of the light-emitting module connection part 38 from the mounting surface 22a of the attachment base 22 is small and is preferably a size smaller than the thickness of a ceramic board 58 of the light-emitting module 23.

Besides, the light-emitting module 23 includes plural light-emitting elements 57 and the ceramic board 58 on which the light-emitting elements 57 are mounted.

For example, an SMD (Surface Mount Device) package is used as the light-emitting elements 57. The light-emitting elements 57 are closely arranged in an arbitrary arrangement on one surface 58a side of the ceramic board 58. Incidentally, as the light-emitting elements 57, a COB (Chip On Board) system may be used in which plural LED chips are mounted on the ceramic board 58 and are integrally sealed with sealing resin containing phosphor, or another semiconductor light-emitting element such as an EL element may be used.

The ceramic board 58 is formed of a metal oxide, such as aluminum oxide (Al₂O₃), aluminum oxide nitride (AlON) or aluminum nitride (AlN), into a substantially square shape, has transparency and is excellent in heat conductivity. A not-shown pattern for electrically connecting the light-emitting elements 57 is formed on the one surface 58a side of the ceramic board 58 on which the light-emitting elements 57 are mounted. A connector 59 (shown in FIG. 3) for electrically connecting the lighting circuit 25 is mounted on the pattern of the ceramic board 58.

The other surface 58b side of the ceramic board 58 of the light-emitting module 23 is disposed so as to contact the light-emitting module connection part 38 and the attachment base 22 through the reflection member 27 and a heat conductive sheet 60. The plural light-emitting elements 57 are disposed in a region of the light-emitting module connection part 38 when viewed from below.

The heat conductive sheet 60 is made of, for example, silicone resin, and has elasticity in addition to heat conductivity and insulation properties. Besides, the heat conductive sheet is formed to be larger than the light-emitting module connection part 38 and the ceramic board 58. That is, the reflection member 27 is formed to be larger than the ceramic board 58, and the ceramic board 58 is disposed inside the outer periphery of the reflection member 27. In other words, the reflection member 27 is formed so as to cover the outer periphery of the ceramic board 58. When the heat conductive sheet 60 is sandwiched between the light-emitting module connection part 38 and the ceramic board 58 and between the attachment base 22 and the ceramic board 58, a step difference between the light-emitting module connection part 38 and the attachment base 22 is absorbed by a difference in compression amount of the insulation sheet 60, and the application of stress to the light-emitting module 23 is relaxed.

The reflection member 27 is made of a metal thin layer, for example, a metal foil having a thickness of 10 to 30 μm, and intervenes between the heat conductive sheet 60 and the other surface 58b side of the ceramic board 58 of the light-emitting module 23. The reflection member 27 is formed to be larger than the ceramic board 58 and to be equal or smaller than the heat conductive sheet 60. The reflection member 27 is formed into a metal foil made of a simple substance or a metal compound of at least one of aluminum (Al), silver (Ag), gold (Au) and copper (Cu), and is formed so that at least a surface 27a at the light-emitting module 23 side has light reflective properties and sliding properties. Here, the sliding properties are physical properties in which when material bodies are contacted each other, one of the material bodies can be easily moved when a force is applied to the one material body in a direction parallel to the contact surface. For example, when a force equal to at least its own weight is applied, the material body to which the force is applied starts to move from a resting state in the direction parallel to the contact surface. The reflection member 27 preferably has higher sliding properties than the heat conductive sheet 60. In this case, a static friction coefficient between the ceramic board 58 and the reflection member 27 is smaller than a static friction coefficient between the ceramic board 58 and the heat conductive sheet 60. Namely, the reflection member 27 has slipping properties, and in this case, for example, has a slippery surface. Having the light reflection properties means that the reflective member reflects, for example, light in at least a visible light wavelength region. For example, the reflection member desirably has a reflectivity of 70% or more in the visible light wavelength. Besides, the reflection member 27 desirably has a higher light reflectivity than the heat conductive sheet.

Incidentally, the reflection member 27 may be integrally provided by, for example, being adhered to the heat conductive sheet 60. For example, the reflection member 27 is adhered to the heat conductive sheet 60 by an adhesive or the viscosity of the heat conductive sheet, and the reflection member 27 and the heat conductive sheet 60 can be integrally provided. By this, the reflection member 27 can be provided at the other surface 58b side of the ceramic board 58 by merely causing the heat conductive sheet 60 to intervene between the light-emitting module connection part 38 and the light-emitting module 23. Besides, the reflection member 27 is not limited to the metal foil, and may be formed of a metal thin layer, for example, a flat thin metal plate.

The reflector 24 is formed of a material having insulation properties, such as synthetic resin. A window hole 62 which is smaller than the outer shape of the ceramic board 58 and through which the light-emitting elements 57 can be inserted is formed at the center of the reflector 24. A recessed positioning part 63 in which the ceramic board 58 is fitted and is positioned is formed on the upper surface of the reflector 24. A reflection surface 64 expanding downward from the peripheral edge part of the window hole 62 to the peripheral part of the reflector 24 is formed. As shown in FIG. 3, plural support pieces 65 supported by the housing 20 are provided at the peripheral part of the reflector 24. Plural attachment holes 66 for screwing the reflector 24 to the attachment base 22 are formed on the reflection surface 64.

Screws 67 inserted through the attachment holes 66 are screwed in the attachment holes 54 of the attachment base 22 and are fastened, so that the reflector 24 is held in the state where the ceramic board 58 is pressed to the light-emitting module connection part 38. At this time, the heat conductive sheet 60 sandwiched between the light-emitting module connection part 38 and the ceramic board 58 and between the attachment base 22 and the ceramic board 58 is compressed, so that the step difference between the light-emitting module connection part 38 and the attachment base 22 is absorbed by the difference in compression amount of the heat conductive sheet 60, and the application of stress to the light-emitting module 23 is relaxed. Besides, the reflector 24 is disposed between the opening part 29 of the housing 20 and the light-emitting module 23, and covers the lighting circuit 25 so that light of the light-emitting elements 57 is not irradiated to the lighting circuit 25.

In this way, as shown in FIG. 1, the light-emitting module 23 is disposed in the housing 20, and the reflector 24 holds the light-emitting module 23 between itself and the light-emitting module connection part 38 of the thermal radiator 21. Besides, the light-emitting module 23 is heat-conductively connected to the light-emitting module connection part 38 through the reflection member 27 and the heat conductive sheet 60. Here, the light-emitting module 23 is provided so that the plural light-emitting elements 57 are positioned in the window hole 62 of the reflector 24. In strictly speaking, the center of the mount area of the light-emitting elements 57 becomes almost the center of the window hole 62. Since the surface 27a of the reflection member 27 which the other surface 58b side of the ceramic board 58 contacts has the sliding properties, the light-emitting module 23 can be easily moved on the surface 27a of the reflection member 27 within the positioning part 63 of the reflector 24. The reflector 24 regulates (positionally restricts) so that the position of the light-emitting module 23 becomes the window hole 62. Incidentally, the reflector 24 is attached to the attachment base 22 by the screws 67 so that the center of the window hole 62 coincides almost the center of a light emission surface of the translucent cover 26 provided in the opening part 29 of the housing 20. An assembling procedure of these is, for example, such that first, in the state where the attachment base 22 is attached to the thermal radiator 21 as shown in FIG. 2, the heat conductive sheet 60 and the reflection member 27 are disposed on the light-emitting module connection part 38. Next, in the state where the light-emitting module 23 is disposed in the positioning part 63 of the reflector 24, the reflector 24 is disposed on the reflection member 27. At this time, since the light-emitting module 23 is positioned by the positioning part 63, the positions of the light-emitting module 23 and the reflector 24 are relatively determined (fixed). Further, the light-emitting module 23 contacts the reflection member 27, and when the reflector 24 is moved relative to the reflection member 27, the light-emitting module 23, together with the reflector 24, moves relative to the reflection member 27. Then, the reflector 24 is fixed to the attachment base 22, so that the light-emitting module 23 can be positioned relative to the reflection member 27. Besides, when the attachment hole 54 of the attachment base 22 and the attachment hole 66 of the reflector 24 are positioned in order to fix the reflector 24 to the attachment base 22, the reflector 24 is moved relative to the reflection member 27 in the state where the light-emitting module 23 is disposed in the positioning part 63 of the reflector 24. At this time, since the reflection member 27 has the sliding properties, the light-emitting module 23 can be easily moved relative to the reflection member 27. Besides, in the case there is a gap between the light-emitting module 23 and the positioning part 63, position control may be achieved by sliding the light-emitting module 23 against the reflection member 27 in the positioning part 63 of the reflector 24.

The reflector 24 reflects part of light emitted from the light-emitting module 23, and cause the light to be emitted from the translucent cover 26 to the external space. Since the light-emitting element 57 emits light in all directions, the light incident on the ceramic board 58 passes through the ceramic board 58 and is incident on the reflection member 27. Here, since the surface 27a of the reflection member 27 has light reflective properties, the incident light is reflected to the ceramic board 58 side, passes through the ceramic board 58, and is emitted from the translucent cover 26 to the external space. As described above, the reflection member 27 facilitates the sliding of the light-emitting module 23 at the time of the positioning of the light-emitting module 23, and further improves the light extraction efficiency of the lamp apparatus 11.

The lighting circuit 25 includes, for example, a power supply circuit which rectifies and smoothes commercial AC power and converts the AC power into DC power, a DC/DC converter which generates a specified DC output from the DC power by a switching operation of a switching element and supplies the output to the light-emitting elements 57 to light the light-emitting elements, and a control IC to control oscillation of the switching element. If the lighting circuit 25 has a dimming function, the lighting circuit has a function in which the current of the light-emitting elements 57 is detected and is compared with a reference value corresponding to a dimming signal, and the switching operation of the switching element is controlled by the control IC.

The lighting circuit 25 includes the circuit board 70 and circuit components 71 as plural electronic components mounted on the circuit board 70.

The circuit board 70 is formed into an annular shape, and a circular fitting hole 72 through which the insertion part 32 of the housing 20 is inserted is formed at the center part of the circuit board 70. The lower surface of the circuit board 70 is a mount surface 70a on which a lead component including a lead wire among the circuit components 71 is mounted, and the upper surface is a wiring surface 70b as a wiring pattern surface or a solder surface to which the lead wire of the lead component is connected by soldering and on which a wiring pattern for mounting a surface mount component among the circuit components 71 is formed.

The circuit board 70 is disposed at an upper side position in the housing 20 so that the wiring surface 70b is directed upward and faces the closing part 30 of the housing 20. The circuit components 71 mounted on the mount surface 70a of the circuit board 70 are disposed among the peripheral surface 28 and the insertion part 32 of the housing 20, the attachment base 22 and the reflector 24.

In FIG. 3, the power supply input side of the circuit board 70 is electrically connected to a pair of lamp pins 73 for power supply, and the lighting output side is electrically connected to the light-emitting module 23. As shown in FIG. 5, the pair of lamp pins 73 for power supply project vertically from the closing part 30 of the housing 20. Incidentally, if the lighting circuit 25 has a dimming function, plural lamp pins 73 for dimming also project vertically from the closing part 30 of the housing 20 in addition to the lamp pins for power supply.

The translucent cover 26 is formed of, for example, a translucent synthetic resin into a disk shape, and is attached to the housing 20 so as to cover the opening part 29 as shown in FIG. 1. A Fresnel lens 75 for controlling the light emitted from the lamp apparatus 11 into a specified luminous intensity distribution is formed on the inner surface (upper surface) of the translucent cover 26 facing the light-emitting module 23. The Fresnel lens 75 has a saw-like sectional shape in the diameter direction and is concentrically formed. A finger-hooking part 76 for facilitating the rotation operation of the lamp apparatus 11 detached and attached to and from the luminaire apparatus 12 (socket) is protrudingly provided on the lower peripheral part of the translucent cover 26. Incidentally, the Fresnel lens 75 may not be provided on the inner surface of the translucent cover 26, and a diffusion surface for diffusing light may be provided.

As shown in FIG. 6, the luminaire apparatus 12 includes a luminaire reflector 81 expanding and opening toward a lower side, a luminaire thermal radiator 82 as a luminaire body attached to an upper part of the luminaire reflector 81, a socket 83 attached to a lower part of the luminaire thermal radiator 82, a terminal base 85 attached to an upper part of the luminaire thermal radiator 82 by an attachment plate 84, and plural not-shown attachment springs for ceiling attachment attached to the periphery of the luminaire thermal radiator 82.

The luminaire reflector 81 is formed into a cylindrical shape expanding downward. Besides, the luminaire thermal radiator 82 is formed of a material, for example, a metal such as aluminum die cast, ceramics, resin excellent in thermal radiation properties or the like. The luminaire thermal radiator 82 includes a disk-shaped base part 87 and plural thermal radiation fins 88 protruding from an upper surface of the base part 87. A flat contact surface 89 exposed in the luminaire reflector 81 is formed on a lower surface of the base part 87.

The socket 83 includes a socket body 91 formed of a synthetic resin having insulation properties into an annular shape, and a not-shown pair of terminals for power supply disposed in the socket body 91. Incidentally, if dimming is supported, plural terminals for dimming are also provided.

A circular insertion hole 92 through which the cap part 50 (projection part 33) of the lamp apparatus 11 is inserted is formed at the center of the socket body 91. Not-shown plural connection holes through which the lamp pins 73 of the lamp apparatus 11 are inserted are formed into a long hole shape along the peripheral direction on the lower surface of the socket body 91. Terminals are arranged on upper sides of the respective connection holes, and the lamp pins 73 of the lamp apparatus 11 inserted in the connection holes are electrically connected to the terminals.

Not-shown plural keys are protrudingly formed on the inner peripheral surface of the socket body 91, and not-shown plural substantially L-shaped key grooves are formed. The keys and the key grooves of the socket 83 and the key grooves 44 and the keys 45 of the lamp apparatus 11 are respectively provided at corresponding positions. The keys 45 and the key grooves 44 of the lamp apparatus 11 are aligned with the key grooves and the keys of the socket 83, and the cap part 50 of the lamp apparatus 11 is inserted into the socket 83. Then, the lamp apparatus 11 is rotated, so that the lamp apparatus 11 can be detachably mounted on the socket 83.

The socket 83 is supported to the luminaire thermal radiator 82 by a support mechanism. The support mechanism is constructed so that when the cap part 50 of the lamp apparatus 11 is mounted on the socket 83, the upper surface of the cap part 50, that is, the external thermal radiation part 39 of the thermal radiator 21 is pressed to the contact surface 89 of the luminaire thermal radiator 82 and the heat conductivity is raised. Besides, the terminal base 85 is electrically connected to the terminal of the socket 83.

As described above, in the luminaire 10 constructed of the lamp apparatus 11 and the luminaire apparatus 12, in order to mount the lamp apparatus 11 to the luminaire apparatus 12, the keys 45 and the key grooves 44 of the cap part 50 are aligned with the key grooves and the keys of the socket 83, and the cap part 50 is inserted into the socket 83. Then, the lamp apparatus 11 is rotated by a specified angle relative to the socket 83. As a result, the keys 45 of the cap part 50 are locked in the key grooves of the socket 83, and the lamp apparatus 11 can be attached to the socket 83. By this, the lamp pins 73 of the cap part 50 are electrically connected to the respective terminals of the socket 83. Besides, the upper surface of the cap part 50, that is, the external thermal radiation part 39 of the thermal radiator 21 is pressed to the contact surface 89 of the luminaire thermal radiator 82 through the thermal conductive sheet 46 and comes in close contact therewith. Thus, heat can be efficiently conducted from the thermal radiator 21 to the luminaire thermal radiator 82.

At the time of lighting of the lamp apparatus 11, commercial AC power is supplied to the lighting circuit 25 of the lamp apparatus 11. The commercial AC power is converted into specified DC power by the lighting circuit 25 and is supplied to the plural light-emitting elements 57 of the light-emitting module 23. As a result, the light-emitting elements 57 are lit. The light of the lit light-emitting elements 57 passes through the translucent cover 26 and is irradiated in a specified irradiation direction. Here, the light emitted from the light-emitting elements 57 to the translucent cover 26 side is incident on the translucent cover 26 directly or after reflected by the reflection surface 64 of the reflector 24, passes through the translucent cover 26 and is irradiated. Besides, the light emitted from the light-emitting elements 57 to the thermal radiator 21 side passes through the translucent ceramic board 58 (light transmissive ceramic board) and is reflected by the light reflective surface 27a of the reflection member 27 toward the ceramic board 58 side. The light again passes through the ceramic board 58 and is incident on the translucent cover 26. The light passes through the translucent cover 26 and is irradiated. Since much of the light emitted from the light-emitting elements 57 is irradiated from the translucent cover 26 in the specified direction, the light extraction efficiency of the lamp apparatus 11 is improved.

Besides, when the light-emitting module 23 is held between the light-emitting module connection part 38 of the thermal radiator 21 and the reflector 24, the light-emitting module can be slid (moved) on the surface 27a of the reflection member 27 having sliding properties. Thus, the plural light-emitting elements 57 are easily positioned and are disposed in the housing 20.

At the time of lighting of the lamp apparatus 11, heat generated by the light-emitting elements 57 of the light-emitting module 23 is mainly conducted from the ceramic board 58 through the reflection member 27 and the heat conductive sheet 60 to the light-emitting module connection part 38 of the thermal radiator 21, the support part 37 and the external thermal radiation part 39. Further, the heat is conducted from the external thermal radiation part 39 through the heat conductive sheet 46 to the luminaire thermal radiator 82, and is radiated to the air from the plural thermal radiation fins 88 of the luminaire thermal radiator 82. By this, the temperature rising of the light-emitting elements 57 is suppressed and the service life is prolonged. Besides, at the time of lighting of the lamp apparatus 11, the heat generated by the lighting circuit 25 is transmitted to the housing 20 and the like, and is radiated to the air from the surface of the housing 20 and the like.

In the lamp apparatus 11 of the embodiment, by the light reflective properties of the reflection member 27, the light from the light-emitting elements 57 passing through the ceramic board 58 is reflected by the reflection member 27 toward the light-emitting module 23 side, and is emitted from the translucent cover 26 to the external space. Thus, the light extraction efficiency of the emitted light of the light-emitting elements 57 can be improved. Further, by the sliding properties of the reflection member 27, the light-emitting module 23 can be easily moved on the surface 27a of the reflection member 27, and the plural light-emitting elements 57 can be easily positioned. Thus, there is an effect that labor saving at the time of manufacture can be realized, and the emitted light of the light-emitting elements 57 can be easily set in a specified irradiation direction.

Besides, the reflector 24 is attached to the attachment base 22 so as to hold the heat conductive sheet 60, the reflection member 27 and the light-emitting module 23 between itself and the light-emitting module connection part 38 of the thermal radiator 21. Thus, there is an effect that the position of the light-emitting module 23 is regulated by the simple structure so that the light-emitting elements 57 are positioned in the window hole 62, and the light-emitting module 23 can be fixed in the housing 20.

Since the reflection member 27 is provided integrally with the heat conductive sheet 60, the reflection member 27 and the heat conductive sheet 60 can be easily provided between the light-emitting module connection part 38 of the thermal radiator 21 and the reflector 24, and labor saving at the time of manufacture can be realized.

Incidentally, in the embodiment, although the lighting apparatus 11 is the lamp apparatus, no limitation is made to this, and the lighting apparatus may be constructed as the luminaire (lighting fixture).

In the Figures, 11 . . . lamp apparatus (lighting apparatus), 20 . . . housing (apparatus body), 21 . . . thermal radiator, 23 . . . light-emitting module, 24 . . . reflector, 27 . . . reflection member, 38 . . . light-emitting module connection part, 57 . . . light-emitting elements, 58 . . . ceramic board, 60 . . . heat conductive sheet.

While certain embodiments have been described, these embodiments have been presented by way of example only, and are not intended to limit the scope of the inventions. Indeed, the novel embodiments described herein may be embodied in a variety of other forms; furthermore, various omissions substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting apparatus comprising:
an apparatus body;
a light-emitting module which includes a light transmissive ceramic board and a light-emitting element provided on one surface side of the ceramic board and is disposed in the apparatus body;
a thermal radiator including a light-emitting module connection part to which the light-emitting module is heat-conductively connected;
a heat conductive sheet intervening between the light-emitting module connection part and the light-emitting module and having insulation properties; and
a reflection member intervening between the heat conductive sheet and other surface side of the ceramic board and having light reflective properties and sliding properties.

2. The apparatus according to claim 1, wherein the reflection member has sliding properties higher than the heat conductive sheet.

3. The apparatus according to claim 2, wherein the reflection member has a light reflectivity higher than the heat conductive sheet.

4. The apparatus according to claim 1, wherein the reflection member is larger than the ceramic board, and the ceramic board is disposed inside an outer periphery of the reflection member.

5. The apparatus according to claim 1, wherein the reflection member is made of a simple substance or a metal compound of at least one of aluminum (Al), silver (Ag), gold (Au) and copper (Cu).

6. The apparatus according to claim 1, wherein the reflection member is provided integrally with the heat conductive sheet.

7. The apparatus according to claim 3, wherein the reflection member is adhered to the heat conductive sheet.

8. The apparatus according to claim 1, further comprising a reflector which holds the light-emitting module between itself and the light-emitting module connection part and regulates a position of the light-emitting module.

9. A lighting apparatus comprising:
an apparatus body;
a light-emitting module which includes a translucent ceramic board and a light-emitting element provided on one surface side of the ceramic board and is disposed in the apparatus body;
a thermal radiator including a light-emitting module connection part to which the light-emitting module is heat-conductively connected;
a heat conductive sheet intervening between the light-emitting module connection part and the light-emitting module and having insulation properties; and
a reflection member intervening between the heat conductive sheet and other surface side of the ceramic board and made of a metal thin layer.

10. The apparatus according to claim 9, wherein the reflection member is made of a metal foil.

11. The apparatus according to claim 9, wherein the heat conductive sheet is made of an insulating resin.
